(19) United States
(12) Patent Application Publication
(10) Pub. No.: US 2021/0185985 A1
(43) Pub. Date: Jun. 24, 2021

(54) MULTI-FUNCTION LEASH

(71) Applicant: Dru Therrian, Chardon, OH (US)

(72) Inventor: Dru Therrian, Chardon, OH (US)

(21) Appl. No.: 17/113,101

(22) Filed: Dec. 6, 2020

Related U.S. Application Data
(60) Provisional application No. 62/950,052, filed on Dec. 18, 2019.

(51) Int. Cl. A01K 27/00

(52) U.S. Cl. CPC A01K 27/003; A01K 27/002

(57) ABSTRACT

A multi-function leash is described including an attachment mechanism with a gated eye secured to a distal end of the leash, allowing the attachment mechanism to be attached in a slideable manner around the leash to form at least one loop, with its travel along the leash restrained by one or more sliding stops that are wider than the gated eye. One of the sliding stops may allow another loop to be formed by drawing the leash through the stop, and another sliding stop may maintain a position along the length of material via an actuator. The leash is configured to provide a sliding loop with a maximum limit and a minimum limit, a sliding loop with a maximum limit and no minimum limit, and various harness configurations, by attaching the attachment mechanism at different locations along the length of material and between different ones of the sliding stops.

This application claims priority to U.S. Provisional Application No. 62/950,052, filed Dec. 18, 2019, the entire contents of which are hereby incorporated by reference for all purposes.

### FIELD OF THE INVENTION

The present invention relates to animal leashes and training aids that can be reconfigured to fit and/or control animals in different ways.

### BACKGROUND OF THE INVENTION

Various leashes and harnesses are known for dogs. For example, U.S. Patent App. Pub. No. 2010/0294212 is directed to a combination animal leash and head controlling device made from a continuous piece of flexible material. The combination animal leash and head controlling device is comprised of a continuous piece of flexible material that controls the animal from a position behind the head. It serves as a leash as well as either a halter or choker collar.

U.S. Patent App. Pub. No. 2013/0074782 is directed to a combination collar and leash training aid that is constructed from a continuous piece of flexible material that serves as a leash as well as a collar, halter, choker or locked flat collar.

U.S. Patent App. Pub. No. 2015/0237831 is directed to pet leash that includes an elongated strap having a fixed loop at a first end for a user to hold, and having an adjustable loop at a second end.

U.S. Pat. No. 6,595,156 is directed to a halter for controlling an animal, such as a dog, having an anchor portion secured across the front of the dog's head terminating at a pair of anchor points on the opposite sides of the animals neck and nape portion extending across the back of the animal's neck slidably received within the anchor portion.

### SUMMARY OF THE INVENTION

Known designs are still limited in their ability to provide user and pet-friendly, reconfigurable leashes and harnesses, that are simultaneously easy to use, adjustable, and secure. The present invention improves on previous designs and allows users to easily adapt a single leash into multiple configurations.

According to first aspects of the invention, a multi-function leash is provided including a length of material having a proximal end and a distal end, with an attachment mechanism secured to the distal end of the length of material. The attachment mechanism may include a gated eye configured to releasably secure the attachment mechanism in a slideable manner around the length of material to form at least one loop.

A first sliding stop may be disposed along the length of material, the first sliding stop having a width that prevents the first sliding stop from passing through the gated eye, and being configured to maintain a position along the length of material when the length of material is under tension.

A second sliding stop may be disposed along the length of material, the second sliding stop having a width that prevents the second sliding stop from passing through the gated eye, and being configured to maintain a position along the length of material via an actuator.

In embodiments, the first sliding stop and the second sliding stop may be configured to limit movement of the attachment mechanism along the length of the material.

In embodiments, the leash may be configured to provide a sliding loop with a maximum limit and a minimum limit, a sliding loop with a maximum limit and no minimum limit, and/or a plurality of harness configurations, by attaching the attachment mechanism at different locations along the length of material and between different ones of the sliding stops.

In embodiments, the proximal end may include a handling loop.

In embodiments, the first sliding stop may be configured to allow a user to pull a portion of the length of material through the first sliding stop to form a loop.

In embodiments, the first sliding stop may include a plurality of first sliding stops disposed distally along the length of material compared to the second sliding stop.

In embodiments, the actuator of the second sliding stop may be configured to allow a user to adjust the second sliding stop along the length of material using one hand.

In embodiments, the attachment mechanism may be a bolt snap.

In embodiments, the bolt snap may be permanently attached to the distal end of the length of material.

In embodiments, the plurality of harness configurations include a harness (e.g. a head harness/halter) including a muzzle loop formed by pulling a portion of the length of material through the first sliding stop, and a second loop formed by securing the attachment mechanism to the length of material at a position between the first sliding stop and the second sliding stop.

In embodiments, the second loop formed by securing the attachment mechanism to the length of material at a position behind the animal's ears, alongside of the jaw or under the chin.

In embodiments, the plurality of harness configurations may include a harness (e.g. a body harness) in which the attachment mechanism is attached to a separate collar, and the length of material extends from the separate collar substantially along an animal's spine, to a point at which the length of material is wrapped around the animal's torso. In embodiments, a similar harness may be formed, for example, by creating a collar by pulling a portion of the length of material through the first sliding stop, and extending the length of material from the collar loop substantially along an animal's spine, to a point at which the length of material is wrapped around the animal's torso.

In embodiments, the plurality of harness configurations may include a harness (e.g. another body harness) in which a first loop is formed by drawing the length of material through the first sliding stop, with the first loop being large enough to fit around a middle of an animal's body. A second loop may then be formed extending in an opposite direction from the first sliding stop, e.g. from between the animal's front legs, and over the animal's head, with the attachment mechanism secured to the length of material at a position behind the animal's head/neck. The length of material may be run under the first loop. The point at which the attachment mechanism is secured to the length of material may be adjusted, e.g. to custom-fit the second loop to the animal, via adjustment of the first and/or second sliding stops.

In embodiments, the length of material is made of nylon.

In embodiments, a link, such as a snap link, may be included that allows yet further harness configurations. For example, in embodiments, a mechanical link may be included that is configured to connect the multi-function leash to a dog collar.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIGS. 1 to 5 show aspects of an exemplary reconfigurable leash, in accordance with an embodiment of the invention;

FIG. 6 shows an example of how a loop of material may be drawn through an adjustable stop of the exemplary reconfigurable leash;

FIG. 7 shows one configuration of the exemplary reconfigurable leash;

FIG. 8 shows an example of how a double loop of material may be formed by the exemplary reconfigurable leash;

FIG. 9 shows another configuration of the exemplary reconfigurable leash;

FIG. 10 shows another configuration of the exemplary reconfigurable leash;

FIG. 11 shows another configuration of the exemplary reconfigurable leash;

FIGS. 12A and 12B shows another configuration of the exemplary reconfigurable leash; and

FIGS. 13 and 14 show another configuration of the exemplary reconfigurable leash including a link.

It is to be expressly understood that the description and drawings are only for the purpose of illustrating certain embodiments of the invention and are an aid for understanding. They are not intended to be a definition of the limits of the invention.

### DETAILED DESCRIPTION OF THE INVENTION

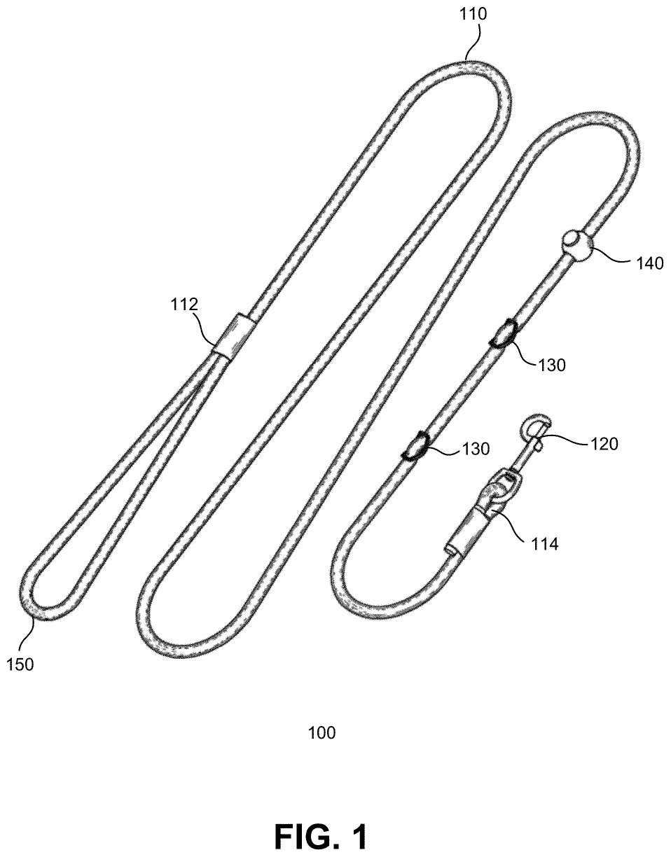

As shown in FIGS. 1-5, an exemplary multi-function leash 100 may include a length of material 110 (e.g. nylon or other leash material) having a proximal end 112 and a distal end 114. A handling loop 150 may be provided at the proximal end 112. An attachment mechanism, such as bolt snap 120, may be secured to the distal end 114 of the length of material 110. The bolt snap 120 includes a gated eye 122 configured to releasably secure the bolt snap 120 around the length of material. In this case, the width of the gated eye 122 is sufficient to encircle the length of material 110, and to allow the bolt snap 120 to slide along the length of material. The bolt snap 120 may be permanently attached to the distal end 114 of the length of material 110.

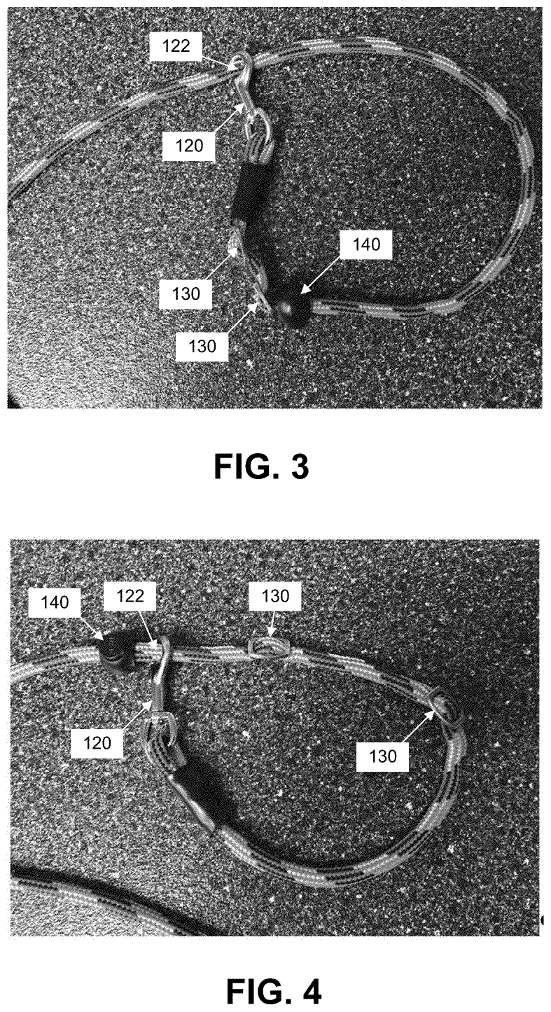

As shown in FIGS. 3-5, and discussed further below, loops of various sizes may be formed by attaching the bolt snap 120 at different positions along the length of material 110.

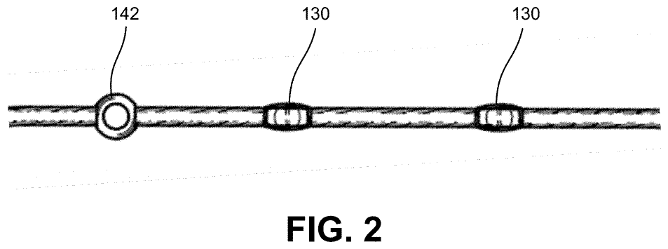

One or more first sliding stops 130 may be disposed along the length of material 110. In this example, two first sliding stops 130 are included. However, there may be none, one, or more than two. The first sliding stops 130 are configured to be adjustable along the length of material 110 between the distal end 114 and the second sliding stop 140. The first sliding stops 130 are further configured to maintain their position(s) once adjustment is complete, e.g. via a combination of tension and friction. In this case, the first sliding stops 130 are metal gates through which the length of material 110 can be threaded, e.g. as shown in FIG. 2.

Each of the first sliding stops 130 has an overall width that prevents the first sliding stop from passing through the gated eye 122, thereby preventing the bolt snap 120 from sliding past the first sliding stops 130 when the bolt snap is secured around the length of material, e.g. as shown in FIG. 4 where the first sliding stop 130 would prevent the bolt snap 120 from sliding to the right.

One or more second sliding stops 140 may also be disposed along the length of material 110. In this example, one second sliding stop 140 is included. However, there may be none, or more than one. The second sliding stop 140 includes a spring-loaded actuator 142 that releases tension on the length of material 110 running through the second sliding stop 140, and allows the position of the second sliding stop 140 to be adjusted with one hand. The second sliding stop 140 has an exterior width that also prevents it from passing through the gated eye 122. As such, each of the first sliding stops 130 and the second sliding stop 140 may be used to limit movement of the bolt snap 120 along the length of the material 110.

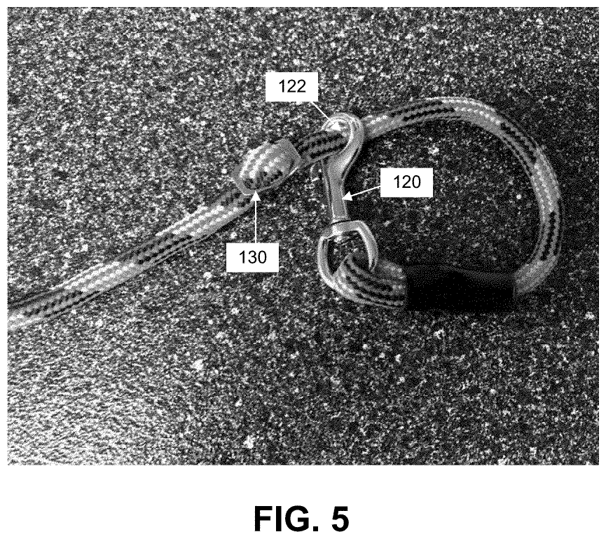

Based on the foregoing combination of features, and as discussed further below, the leash 100 may be configured in various ways, e.g. to provide a sliding loop with a maximum limit and a minimum limit (as shown in FIG. 4), a sliding loop with a maximum limit and no minimum limit (as shown in FIG. 5), and/or a plurality of harness configurations (as shown in FIGS. 7-12), by attaching the bolt snap 120 at different locations along the length of material 110 and between different ones of the sliding stops 130, 140, and/or extending lengths of the material 110 out of specific first sliding stops 130 to form additional loops.

Referring to FIG. 3, a “slip line” may be formed with bolt snap 120 hooked on the length of material 110 with the sliding stops 130, 140 positioned without limiting movement of the bolt snap 120 within a normal range, i.e. the approximate circumference of the pet's neck. The sliding stops 130, 140 could also be moved to the proximal end of the leash 100 to achieve a similar effect.

FIG. 4 shows an alternative configuration, in which a limited slip line is formed with bolt snap 120 hooked on the length of material 110 between sliding stops 140, 130, which are positioned to limit movement of the bolt snap 120, thereby controlling the maximum amount of constrictive force applied by the leash 100 on the dog's neck.

As shown in FIG. 5, the bolt snap 120 can instead be attached at a point distal of each of the stops, thereby controlling a maximum circumference of the formed loop without limiting constriction, e.g. for extremely small dogs or other pets.

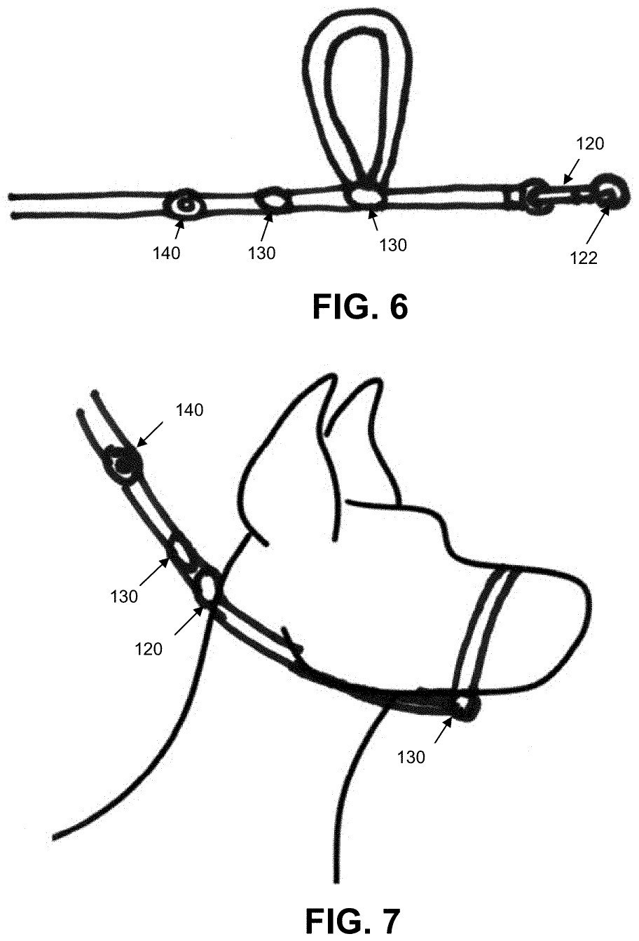

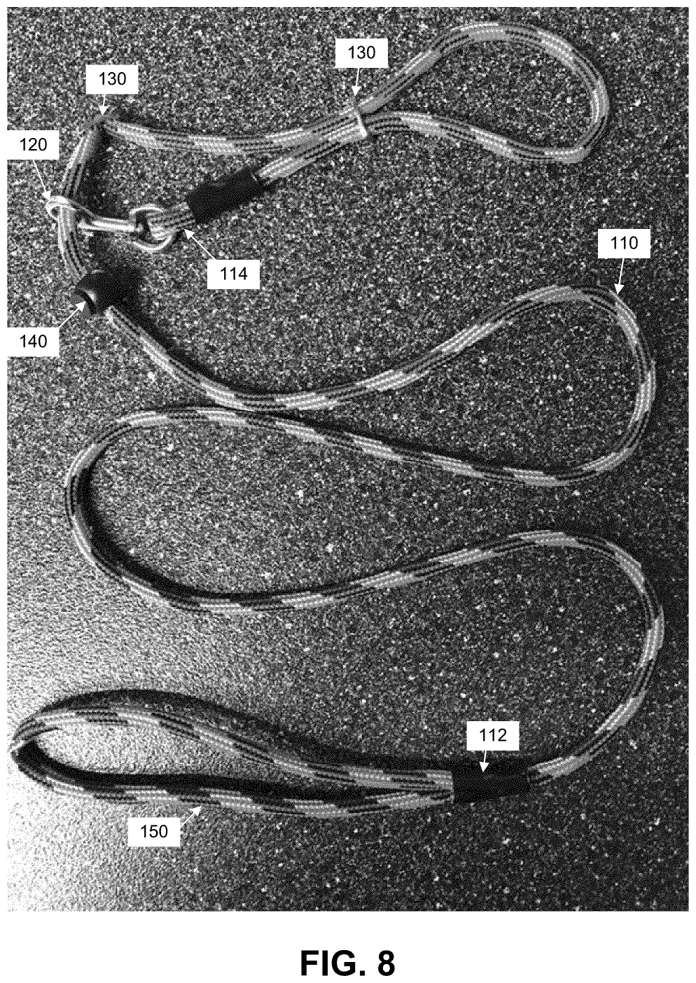

As shown generally in FIG. 6, the first sliding stops 130 may be configured to allow a user to pull a portion of the length of material 110 through the first sliding stop 130 to form a loop. For example, each of the first sliding stops 130 may be configured in a figure-8 or similar shape, whereby the length of material runs in one eye, over a middle bar, and out the other eye. By pulling the length of material away from the middle bar, material may be drawn in from either or both eyes, and form a loop. This can be advantageously used in a number of ways. For example, as shown in FIG. 7, a loop like shown in FIG. 6 may be used as a muzzle portion of a head harness, with the bolt snap 120 connected back to the length of material 110 at a position behind the dog's head. The bolt snap can be secured distally to the other first sliding stop 130 (as shown in FIG. 7) to allow constriction of the loop encircling the dog's neck, or it may be secured proximally to the other first sliding stop 130 (as shown in FIG. 8) to prevent constriction of the loop encircling the dog's neck.

Thus, as shown in FIGS. 7 and 8, various harness configurations (e.g. a head harness/halter) may include a muzzle loop formed by pulling a portion of the length of material 110 through the first sliding stop 130, and a second loop formed by securing the bolt snap 120 to the length of material 110 at a position between one of the first sliding stop 130 and the second sliding stop 140, or between the two first sliding stops 130.

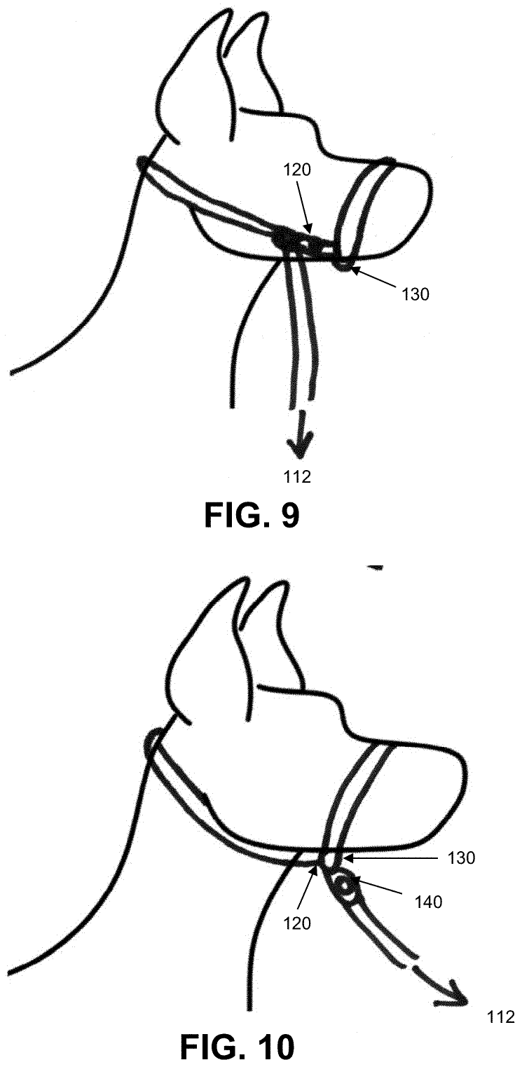

As shown in FIG. 8, a user can easily prepare a head harness/halter simply by forming a muzzle loop using the sliding stop 130 closest to the bolt snap 120 sized to slip on and around the dog's muzzle. Then, the bolt snap 120 can easily be hooked onto the length of material 110 behind the dog's ears (as in FIG. 7), along side of the jaw (as in FIG. 9) or under the chin (as in FIG. 10).

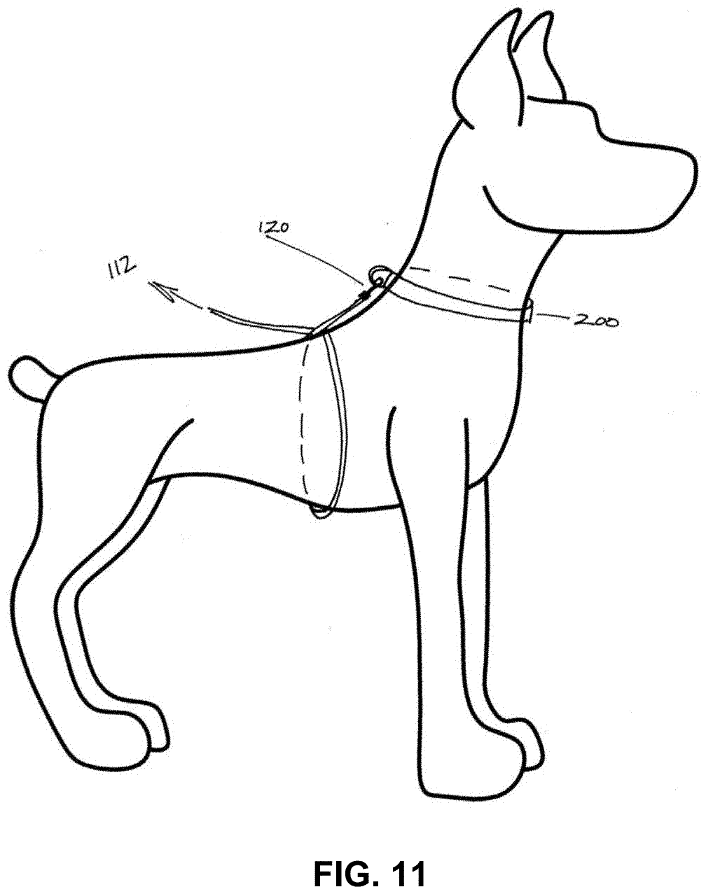

As shown in FIG. 11, a body harness may also be formed simply by clipping the bolt snap 120 to a separate collar 200, having the length of material 110 drawn along the spine, wrapping around the middle of the body and under itself, and pulling up, creating a large loop around the dog's body. A similar configuration can be achieved by forming a collar from the leash 100 using the bolt snap 120, e.g. as shown in FIG. 4, and then drawings the length of material 110 that is proximal of second sliding stop 140 along the spine, wrapping it around the middle of the body, and pulling up, creating a loop around the dog's body much as shown in FIG. 11 (without using a separate collar 200).

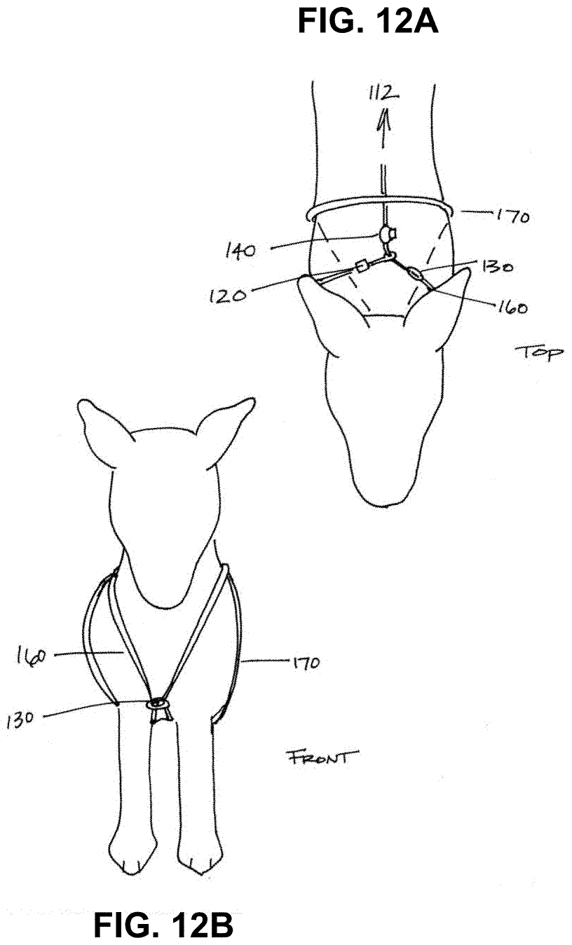

As shown in FIGS. 12A and 12B, a body harness may also be formed by creating two large loops 160, 170 using the sliding stops 130, 140 and bolt snap 120. One loop 170 (formed, for example, as shown in FIG. 6) may be put around the middle of body, then the second loop 160 pulled up between the two front legs and over the dog's head to the back of the neck where the bolt snap is attached to the length of material 110 between second sliding stop 140 and a first sliding stop 130, as shown in FIG. 12A. The fit of the body harness may be secured by pulling the handling loop 150 or proximal end 112 under the loop 170 across the dog's back. Stops 140 and 130 (seen from the top view FIG. 12A) may be used to set a certain length that limits the fit and/or force on the dog's chest.

As will be appreciated, although the foregoing description of embodiments have generally referred to the first sliding stop(s) as capable of forming loops and the second sliding stop(s) as including an actuator that makes it capable of easy adjustment with one hand, the invention is not necessarily limited to using only the specific sliding stops in the number and arrangement described. For example, a multi-function leash may also be formed using only one first sliding stop, and/or one or more second sliding stops

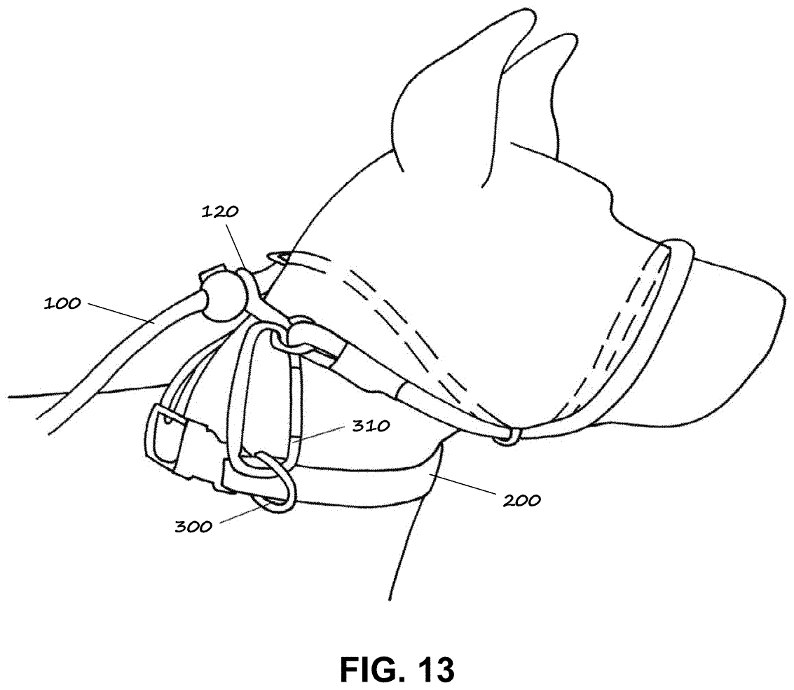

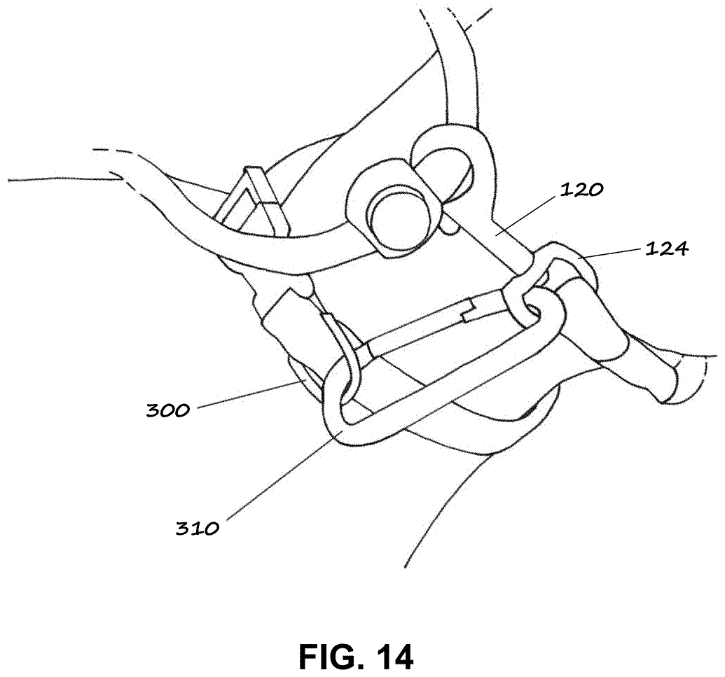

FIGS. 13 and 14 depict additional configurations of an exemplary leash that may be achieved by adding a link, such as mechanical snap link 310 to the leash 100. In this example, a snap link 310 may be attached to the leash 100, e.g. through the closed end 124 of snap link 120. The snap link 310 may also be attached to a D-ring, or other portion, of collar 200. In the example shown in FIGS. 13 and 14, a muzzle loop is drawn through one of the first sliding stops 130, as previously described, and the snap link 120 is connected to the length of material between the second sliding stop 140 and the other first sliding stop 130. This configuration can be readily attached to the dog's collar 200 via the link 310, thereby resisting and/or preventing, for example, the dog backing its head out of the head harness/halter. Thus, the leash 100 may be advantageously integrated with standard collars used by pet owners, or used independently as variously described herein.

Any feature of any embodiment discussed herein may be combined with any feature of any other embodiment discussed herein in some examples of implementation.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

Although various embodiments and examples have been presented, this was for the purpose of describing, but not limiting, the invention. Various modifications and enhancements will become apparent to those of ordinary skill in the art and are within the scope of the invention, which is defined by the appended claims.

What is claimed:

1. A multi-function leash, comprising:
a length of material having a proximal end and a distal end,
an attachment mechanism secured to the distal end of the length of material, the attachment mechanism including a gated eye configured to releasably secure the attachment mechanism in a slideable manner around the length of material to form at least one loop;
a first sliding stop disposed along the length of material, the first sliding stop having a width that prevents the first sliding stop from passing through the gated eye, and being configured to maintain a position along the length of material when the length of material is under tension; and
a second sliding stop disposed along the length of material, the second sliding stop having a width that prevents the second sliding stop from passing through the gated eye, and being configured to maintain a position along the length of material via an actuator,
wherein, the first sliding stop and the second sliding stop are configured to limit movement of the attachment mechanism along the length of the material, and
wherein, the leash is configured to provide a sliding loop with a maximum limit and a minimum limit, a sliding loop with a maximum limit and no minimum limit, and a plurality of harness configurations, by attaching the attachment mechanism at different locations along the length of material and between different ones of the sliding stops.

2. The leash of claim 1, wherein the proximal end includes a handling loop.

3. The leash of claim 1, wherein the first sliding stop is configured to allow a user to pull a portion of the length of material through the first sliding stop to form a loop.

4. The leash of claim 1, wherein the first sliding stop includes a plurality of first sliding stops disposed along the length of material distal of the second sliding stop.

5. The leash of claim 1, wherein the actuator of the second sliding stop is configured to allow a user to adjust a position of the second sliding stop along the length of material using one hand.

6. The leash of claim 1, wherein the attachment mechanism is a bolt snap.

7. The leash of claim 6, wherein the bolt snap is permanently attached to the distal end of the length of material.

8. The leash of claim 1, wherein the plurality of harness configurations include a harness including a muzzle loop formed by pulling a portion of the length of material through the first sliding stop, and a second loop formed by securing the attachment mechanism to the length of material at a position between the first sliding stop and the second sliding stop.

9. The leash of claim 8, wherein the second loop is formed by securing the attachment mechanism to the length of material at a position behind the animal's ears, alongside of the jaw or under the chin.

10. The leash of claim 1, wherein the plurality of harness configurations include a harness in which the attachment mechanism is attached to a separate collar, and the length of material extends from the separate collar substantially along an animal's spine, to a point at which the length of material is wrapped around the animal's torso.

11. The leash of claim 1, further comprising a mechanical link, wherein the mechanical link is configured to attach to the attachment mechanism and a separate collar.

12. The leash of claim 11, wherein the plurality of harness configurations include a harness in which a muzzle loop is formed by pulling a portion of the length of material through the first sliding stop, a second loop sized to fit around a dog's neck is formed by securing the attachment mechanism to the length of material at a position between the first sliding stop and the second sliding stop, and the attachment mechanism is attached to the separate collar via the mechanical link.

13. The leash of claim 1, wherein:
the plurality of harness configurations include a harness in which a first loop is formed by pulling a portion of the length of material through the first sliding stop, with the first loop being large enough to fit around a middle of an animal's body;
a second loop is formed extending in an opposite direction from the first sliding stop with the second loop secured behind the animal's head or neck via the attachment mechanism, and with the size of the second loop being adjustable by adjusting the position(s) of the first sliding stop and/or the second sliding atop along the length of material; and
the length of material runs from the second loop under the first loop.

14. The leash of claim 1, wherein the length of material is made of nylon.

15. A multi-function leash, comprising:
a length of material having a proximal end and a distal end,
an attachment mechanism secured to the distal end of the length of material, the attachment mechanism including a gated eye configured to releasably secure the attachment mechanism in a slideable manner around the length of material to form at least one loop;
a pair of first sliding stops disposed along the length of material, each of the first sliding stops having a width that prevents each of the first sliding stops from passing through the gated eye, and being configured to maintain a position along the length of material when the length of material is under tension; and
a second sliding stop disposed along the length of material, the second sliding stop having a width that prevents the second sliding stop from passing through the gated eye, and being configured to maintain a position along the length of material via an actuator,
wherein, at least one of the first sliding stops is configured to allow a user to pull a portion of the length of material through the at least one of the first sliding stops to form a loop;
wherein, the pair of first sliding stops and the second sliding stop are configured to limit movement of the attachment mechanism along the length of the material, and
wherein, the leash is configured to provide a sliding loop with a maximum limit and a minimum limit, a sliding loop with a maximum limit and no minimum limit, and a plurality of harness configurations, by attaching the attachment mechanism at different locations along the length of material and between different ones of the sliding stops.

16. The leash of claim 15, further comprising a mechanical link, wherein the mechanical link is configured to attach to the attachment mechanism and a separate collar.

17. The leash of claim 16, wherein the plurality of harness configurations include a harness in which a muzzle loop is formed by pulling a portion of the length of material through the at least one of the first sliding stops, a second loop sized to fit around a dog's neck is formed by securing the attachment mechanism to the length of material at a position between the pair of first sliding stops and the second sliding stop, and the attachment mechanism is attached to the separate collar via the mechanical link.

18. The leash of claim 15, wherein the plurality of harness configurations include a harness including a muzzle loop formed by pulling a portion of the length of material through the at least one of the first sliding stops, and a second loop formed by securing the attachment mechanism to the length of material at a position between the pair of first sliding stops and the second sliding stop.

19. The leash of claim 15, wherein the attachment mechanism is a bolt snap.

20. The leash of claim 19, wherein the bolt snap is permanently attached to the distal end of the length of material.
